(19) United States
(12) Patent Application Publication
(10) Pub. No.: US 2019/0327552 A1
(43) Pub. Date: Oct. 24, 2019

(54) NEGATIVE STIFFNESS AND LOW FREQENCY SPEAKERS AND OTHER ACOUSTICS

(71) Applicant: Leib Morosow, Brooklyn, NY (US)

(72) Inventor: Leib Morosow, Brooklyn, NY (US)

(21) Appl. No.: 16/400,754

(22) Filed: May 1, 2019

Related U.S. Application Data
(63) Continuation-in-part of application No. 15/822,773, filed on Nov. 27, 2017.
(60) Provisional application No. 62/784,629, filed on Dec. 24, 2018.
(60) Provisional application No. 62/714,912, filed on Aug. 6, 2018.
(60) Provisional application No. 62/677,069, filed on May 28, 2018.
(60) Provisional application No. 62/665,352, filed on May 1, 2018.

(51) Int. Cl. H04R 1/28; H04R 1/02

(52) U.S. Cl. CPC H04R 1/2811; H04R 2499/13; H04R 1/025

(57) ABSTRACT

Improved forms of negative stiffness are disclosed, also three general acoustic products are described herein, lower frequency speakers, lower frequency acoustic absorbers, and lower frequency acoustic blockers. the common denominator between these products is that they comprise a body of air, in an enclosure, that contracts and expands with every (lower frequency) wave, they may therefore utilize negative stiffness to counteract the (positive) stiffness of said body of air, making said body of air appear more compliant, and these enclosures may therefore comprise a non-stretch layer held taut by air pressure thus allowing for lighter and/or collapsible enclosures, particularly useful in slightly modified aircraft, said non-stretch layer may also serve as a diaphragm.

### FIELD OF INVENTION

Negative stiffness, lower frequency speakers and acoustic energy absorbers and blockers.

### BACKGROUND OF INVENTION

In an effort to make the content of this document comprehensible, it has been broken up into many sections, however this is artificial, there is a lot of overlap between sections and most sections can be significantly enhanced by the contents in other sections and any enhancements in one section may be applicable in other sections as well.

Improved forms of negative stiffness are disclosed, also three general acoustic products are described herein, lower frequency speakers, lower frequency acoustic absorbers, and lower frequency acoustic blockers. the common denominator between these products is that they comprise a body of air, in an enclosure, that contracts and expands with every (lower frequency) wave, they may therefore utilize negative stiffness to counteract the (positive) stiffness of said body of air, making said body of air appear more compliant, and these enclosures may therefore comprise a non-stretch layer held taut by air pressure thus allowing for lighter and/or collapsible enclosures, particularly useful in slightly modified aircraft, said non-stretch layer may also serve as a diaphragm.

Regarding Negative Stiffness:

Stiffness equals change in force divided by change in position (displacement) i.e. the derivative of force vs position, however whereas (positive) stiffness is a force that increases as you move against it, negative stiffness is a force that decreases as you move against it, e.g. a tall heavy bookshelf leaning against a wall at a forty-five-degree angle, as you try to push it upright you find that, unlike a spring, the farther you push it the less it pushes back at you, that is negative stiffness. If this bookshelf only had one, narrow edged, leg to balance on, its negative stiffness vs position graph would approach a horizontal line (constant) as the bookshelf approached a vertical position, i.e. the force vector would very steadily shrink to zero and then reverse direction, this zero position occurs when the bookshelf is perfectly balanced on its one narrow leg, it can be seen from here that the zero position of a negatively stiff object has unstable equilibrium, whereas the zero position of a positively stiff object has stable equilibrium.

Since negative stiffness is simply a force that varies with position, it can easily be reproduced by combining a simple spring with a device that applies leverage that varies with position, e.g. noncircular gears will apply leverages that vary with position, so will a bookshelf, i.e. gravity has less leverage when the bookshelf is vertical, essentially any mechanism that has interconnected members that move at velocities that vary relative to each other (i.e. being none linearly related) will also result in varying leverages that are correlated to these relative velocities, even the varying x and y velocity components of any single moving member can create varying leverage, e.g. a coaster slidably attached to a curved track, and connected to two tension members that are perpendicular to each other (one pulling it in the x direction, and the other pulling it in they direction), as the angle (i.e. the x and y components) of the curved track, that the coaster is riding on, changes, so will the leverage ratio between the two tension members. Such a coaster on a curved track can take practically any stiffness vs position curve (e.g. from a spring), and turn it into, practically, any other stiffness vs position curve, including a negative stiffness vs position curve. However, it is difficult to create a mechanism that utilizes varying leverage to produce negative stiffness that has a high enough strength to weight ratio and is durable enough (able to survive billions of vibrations) for many applications e.g. acoustics, automobile suspension, and other vibration related applications.

Magnets can also be used to produce negative stiffness. Magnetic attraction is inherently negatively stiff (i.e. it's a force that gets weaker as you move against it), however, its negative stiffness is commonly not nearly constant because the force between magnets is affected by the inverse square law (and if the two poles of a given magnet are relatively close to each other it may even follow the inverse cubed law because the poles cancel each other), i.e. as attracting magnets approach each other the negative stiffness they produce gradually spikes upwards, this is a problem because to counteract positive stiffness the negative stiffness should be a mirror image to said positive stiffness, and most common forms of positive stiffness are at least somewhat constant, i.e. stiffness being almost the same independent of position (e.g. air that is compressed/decompressed by 1 percent will exhibit close to constant stiffness, but not completely, because air compressed by 1 percent will have a pressure increase of about 1.4 percent, the “about 0.4” is due to heating, and stiffness is a product (derivative) of pressure (force), additionally, since the volume is now 1 percent smaller, any similar volume change now will equate to a 1 percent greater volume change, the result being, air compressed by 1 percent is about 2.4 percent stiffer).

Magnetic repulsion is NOT inherently negatively stiff (i.e. it's NOT a force that gets weaker as you move against it), however repelling magnets can also be used to produce negative stiffness e.g. where the moving magnet is only allowed to move in a straight line and where at one point in space this straight line is perpendicular to the repulsive force of the stationary magnet, that point we can call point-zero because it is the point of unstable equilibrium because for any point on this straight line, the farther it is from point-zero, the less perpendicular said line is to the repulsive magnetic lines of force spreading outwards from the stationary magnet. However, this is very inefficient because it relies on the actual distance between the magnets not changing much, and that means that only a small percentage of the magnets potential energy can be tapped into. So improved forms of negative stiffness are disclosed herein.

Regarding Speakers with Negative Stiffness:

Higher quality (sub) woofers are affixed to a sealed box, or enclosure, this is to keep the large soundwaves that are generated in front of the diaphragm from being canceled by the large (negative) soundwaves that are generated behind the diaphragm, however the air in the sealed enclosure is somewhat stiff i.e. not wanting to easily contract and expand, and the spider and surround are also somewhat stiff, this makes it very difficult to move the diaphragm back and forth, so many patents have been published over the years to try to solve this ‘stiffness’ problem, many have suggested the use of negative stiffness to cancel said stiffness (in this document “cancel” usually means “partially cancel”).

Among the first of these are U.S. Pat. No. 2,810,021(A) and U.S. Pat. No. 2,846,520(A), these suggest mechanical means for producing the needed negative stiffness, however these ideas are problematic because upon close inspection it becomes increasingly clear that the described mechanism will become noisy and will very quickly wear out and break down. More recent patents, like U.S. Pat. No. 6,574,346B1 and U.S. Pat. No. 7,454,025B2 (see also the patents to which said patents refers to) suggest using magnets to produce the necessary negative stiffness, the problem with these is that the magnets will need to be relatively heavy, this will make it overly difficult to vibrate the diaphragm at the slightly higher frequencies, e.g. above 60 Hz, but perhaps more importantly, the negative stiffness produced with said magnets is not nearly constant enough over a meaningful percentage of the magnets affective range, that means that only a small percentage of the magnets affective range can be used, e.g. even if the force between the stationary magnet and moving magnet is still strong when they are 30 millimeters apart, the moving magnet must still not be allowed to move, to and fro, more than, perhaps, a couple of millimeters, and that means that only a small percentage of the magnets potential energy can be tapped into.

Regarding Speakers Comprising a Non-Stretch Layer:

Higher quality (sub) woofers are affixed to a sealed box, or enclosure, this is to keep the large soundwaves that are generated in front of the diaphragm from being canceled by the large (negative) soundwaves that are generated behind the diaphragm, for this to work the walls of this enclosure must resist vibrating because the volume of the enclosure cannot be allowed to change but for the movement of the diaphragm(s), the bulk modulus of the enclosure, if the diaphragm(s) was not allowed to move relative to the enclosure, should be at least five, ten, or more, times greater than the bulk modulus of the air that fills the enclosure, (and since the surface area of the enclosure, or box, is many times larger than the surface area of the diaphragm, it doesn't take much of said wall vibrations to cause significant sound cancelation), this can be done by making the walls of the enclosure stiff and/or heavy (if it's stiff enough it's probably relatively heavy as well), the enclosure also needs to be relatively big because the bigger the enclosure the easier it will be to move the diaphragm, but a bulky enclosure is a problem where space is limited e.g. inside a car.

So a light-weight and collapsible enclosure can rely on a flexible layer that relies on an air pressure difference to help keep its shape, e.g. if the air pressure inside the enclosure is kept positive (always greater than the pressure outside), then the enclosure can be made so light-weight that its walls are not stiff enough to maintain their exact shape but must rely on said positive pressure to maintain their exact shape and thus the enclosure's exact volume, but the walls need to be non-stretch (having a high Young's modulus to weight ratio so if the young's modulus is not quite high enough the walls may be made thicker) otherwise the volume will change due to the small pressure changes in the larger soundwaves (we don't care about the effects of smaller waves because we are not trying to control them). A collapsible enclosure can use wall segments that flex easily e.g. like fabric, however if the enclosure is designed to be light-weight but not collapsible i.e. with walls that are a little harder to flex, then they may need to be predesigned with the exact shape they will take when under significant positive air pressure, otherwise small pressure changes may affect their exact shape. Rounded shapes can be chosen to eliminate stress points.

The diaphragm too may comprise a non-stretch layer. FIG. 1 in U.S. Pat. No. 2,846,520(A) shows a speaker with a pressurized enclosure and a diaphragm comprising a non-stretch layer held taut by the air pressure, such a diaphragm could be made with a much higher strength to weight ratio than conventional cone shaped diaphragms, a lighter diaphragm can handle the higher g-forces inherent in higher frequencies, so any frequency speakers, including woofers, and tweeters, may benefit from this. There is a common assumption that an adequately non-stretch layer cannot be made very flexible and if folded will develop permanent creases, that may be one of the reasons the inventor didn't think of using said non-stretch layer to create a collapsible enclosure. Other issues with said figure include: the tension that the diaphragm exerts on the surround may be unacceptable, also the spring that keeps the diaphragm centered presents problems because a spring that can supply the necessary force must either add a lot of stiffness or a lot of mass to the diaphragm thus hindering its ability to vibrate, and at the slightly higher frequencies will create echoes (due to waves traveling back and forth through the spring) that will be distorted due to the lack of absolute symmetry of the spring. Still if the spring is kept under its fatigue-limit it can function forever.

Regarding Absorbing Sound:

Low frequency sound is very difficult to absorb because low frequency sound absorbers, like bass-traps, can only absorb energy that is temporarily stored in the contractions and expansions of a trapped body of air, this is why bass traps are commonly placed near walls and corners, because there the air pressures of the incident waves and reflected waves always support each other, resulting in greater air contractions and expansions. And since low frequency sound has fewer contractions and expansions it is harder to absorb, (so a larger sound wave requires a larger body of trapped air to match its size).

It can be compared to an electric circuit with a high impedance capacitor that limits the current flow in a wire and therefore limits the amount of energy a resistor in series with said capacitor may absorb, the capacitor's capacitance is analogues to the compliance in our trapped body of air, and the resistor is the damping mechanism. A common, but very limited, fix to this problem is to add mass, creating a—low frequency—resonator (this mass can also come in the form of a bottleneck/channel filled with air, as in a Helmholtz resonator, although it may be very little mass, it behaves as though it is a lot of mass due to the narrow channel).

Adding mass to a trapped body of air is like adding an inductor in series to our capacitor, this creates a circuit that will resonate at the frequency at which the inductor impedance fully cancels the capacitor impedance and will also have a somewhat lower impedance at frequencies nearby where the inductor impedance and capacitor impedance only partially cancel each other.

Although adding mass can cancel the impedance resulting from lack of compliance (stiffness), it's only very affective for a very narrow bandwidth, so it would be much better if we could replace the air with something more compliant, but all gases are equally compliant, and volatile liquids, i.e. refrigerants, are way more trouble than they are worth, but what we can do is use negative stiffness to make the air appear more compliant. (Note that most references to “air” in this document may also refer to other gases.)

Chinese patents CN104751836(A) and CN105551478(A) disclose devices that use attracting magnets to apply negative stiffness to a trapped body of air in an enclosure thus canceling a portion of the stiffness of said body of air, making said body of air appear more compliant so that they may absorb more sound energy, they describe a hollow container open on one side and a diaphragm covering said opening effectively sealing the air inside, and a magnet (or magnets) connected to the container attracting a magnet (or magnets, or iron) on the diaphragm. The English translation is not so clear so it is worth noting here that if these devices include damping means then they will absorb sound, otherwise they will only reflect some sound. However, these devices can use improvements, some of which are similar to those in the above described speaker. The improvements described in this document to products that utilize negative stiffness, apply whether they use magnets or other means of negative stiffness, e.g. leverage that varies with position.

Regarding Blocking Sound:

Besides being very difficult to absorb, low frequency sound is also difficult to block (i.e. fully reflect and/or absorb) because a wall that affectively blocks a sound wave may have a mass that is over a hundred times greater than the air mass that composes that sound wave so that when the air mass of that sound wave hits the wall it will result in very little motion of the wall, and low frequency soundwaves have much more mass due to their large size, so only a very heavy (or extremely stiff or extremely thick) wall can block them, another way to put this is, because the forces on the wall change direction less often when the frequency is low the wall has more time to accelerate and build up velocity, and when the wall has velocity and vibrates that causes the air on the other side of the wall to, also, vibrate.

Very heavy (or extremely stiff or extremely thick) walls are not always possible, a partial solution to this problem is to create two walls with an air gap sandwiched between them, the compliance of the air in this gap serves to somewhat isolate these walls from each other (if there are points where these two walls are connected to each other, those connections should be springy, not rigid, otherwise the section of wall close to that connection won't be as affective at blocking the sound), The electric circuit analogy is that instead of using one very large inductor to block even the low frequencies, we use two inductors in series, and add a shunt capacitor between them, and the capacitor will divert some of the AC away from reaching the second inductor, the shunt capacitor represents, of course, the air gap.

Unfortunately, this air gap must often be prohibitively large, one way around this problem is to somehow make the air more compliant, thus requiring only a relatively small air gap to significantly isolate the two walls from each other, here, again, negative stiffness is the only practical solution. While highly compliant devices don't require walls to reflect low frequency sound (they may even reflect sound away from a window or doorway without actually blocking said window or doorway), they work much better when combined with walls, because, their low impedance, and the wall's high impedance, create an extreme impedance mismatch. They can be very useful on aircraft, they may also be very useful in muffling (absorbing and/or reflecting) engine noise as well as in ductwork etc. etc. The above mentioned Chines patents don't seem to address sound-blocking, even if the arrangement of devices as described in patent CN105551478(A) were part of a complete wall, they would still not block sound well, because since every device is tuned differently one of them is sure to cause a resonance that will let a lot of sound through.

Regarding a Non-Stretch Layer Held Taut by Air Pressure:

Whether they do or don't use negative stiffness, the acoustic products described herein comprise a substantially air tight enclosure to trap a body of air (or gas), the walls of said enclosure cannot be allowed to vibrate because the volume of the enclosure cannot be allowed to change but for the movement of the diaphragm(s). If such an enclosure can be made very light-weight it would be particularly useful on aircraft, where noise is a common problem, it would allow for very light-weight sound blocking and absorbing, it can allow for very light-weight resonators as explained later, it can also allow for very light-weight active noise canceling as explained later.

So a light-weight enclosure can rely on a non-stretch layer that relies on an air pressure difference to help keep its shape, e.g. if the air pressure inside the enclosure is kept positive (always greater than the pressure outside), then the enclosure can be made so light-weight that its walls are not stiff enough to maintain their exact shape but must rely on said positive pressure to maintain their exact shape and thus the enclosure's exact volume, but the walls need to be non-stretch (having a high Young's modulus to weight ratio so if the young's modulus is not quite high enough the walls may be made thicker) otherwise the volume will change due to the small pressure changes in the larger soundwaves, A collapsible enclosure can use wall segments that flex easily e.g. like fabric, however if the enclosure is designed to be light-weight but not collapsible i.e. with walls that are slightly harder to flex, then they may need to be predesigned with the exact shape they will take when under significant positive air pressure, otherwise small pressure changes may affect their exact shape, this may not be a problem around the diaphragm area where movement is expected. Rounded shapes can be chosen to eliminate stress points.

### BRIEF SUMMARY

Improved forms of negative stiffness are disclosed, also three general acoustic products are described herein, lower frequency speakers, lower frequency acoustic absorbers, and lower frequency acoustic blockers. the common denominator between these products is that they comprise a body of air, in an enclosure, that contracts and expands with every (lower frequency) wave, they may therefore utilize negative stiffness to counteract the (positive) stiffness of said body of air, making said body of air appear more compliant, and these enclosures may therefore comprise a non-stretch layer held taut by air pressure thus allowing for lighter and/or collapsible enclosures, particularly useful in slightly modified aircraft, said non-stretch layer may also serve as a diaphragm.

The detailed description below is broken up into the following sections:
Prerequisite specifications of basic components utilized herein:
Regarding shaping negative stiffness by adding positive stiffness:
Regarding shaping negative stiffness by designing accurate magnets:
Regarding speakers with negative stiffness:
Regarding speakers comprising a non-stretch layer:
Regarding speakers that combine negative stiffness and a non-stretch layer:
Regarding sound absorbers and/or blockers that utilize negative-stiffness:
Regarding a non-stretch layer held taut by air pressure:
Regarding blocking the lower frequencies with light-weight aircraft walls:

### BRIEF DESCRIPTION OF DRAWINGS

FIG. 1a is a side view of non-stretch tension members bending safely around curved surfaces thus keeping said curved surfaces secure from sliding against each other.

FIG. 1b shows the contents of FIG. 1a from another angle, but, unlike in FIG. 1a, one of said curved surfaces has been removed to allow a better view of said non-stretch tension members.

FIG. 2 shows lever comprising curved surface (which may be secured as in FIG. 1) which results in a moving fulcrum that produces positive stiffness.

FIG. 3 shows a speaker using negative stiffness.

FIG. 4 shows a speaker comprising a non-stretch layer.

FIG. 5 shows a speaker combining negative stiffness with a non-stretch layer.

FIG. 6 shows an enclosure comprising a non-stretch layer.

FIG. 7 shows how to make a super light-weight resonator

FIG. 8 shows a curtain of PNSD situated between two (aircraft) wall panels.

### DETAILED DESCRIPTION

Prerequisite Specifications of Basic Components Utilized Herein:

Most vibrating members of embodiments specified in this document will need to be very stiff (and light-weight) so that they may carry (transmit) said vibrations, some members, e.g. levers, will need bending stiffness and some members, e.g. tension members, may make do with only tension stiffness (being non-stretch). Stiff (and light) materials, having a high Young's modulus, can easily be found with an internet search, and how to shape a lever so that it is stiff yet light (parts that accelerate the most should be lightest) is also well known in the art. Many non-vibrating members of embodiments specified herein will also need to be very stiff (and possibly heavy) to keep from vibrating.

Any pivotally vibrating levers or members (who's vibrations are manifested in a pivoting motion) of embodiments specified herein will usually only be required to pivot a few degrees or less, for this reason we can mostly do away with conventional hinges, because they create friction and noise, and replace them with members that can bend elastically, however we still need to worry about wear or fatigue, so the following are a few steps that can be taken to significantly reduce wear or fatigue on bending members, e.g. keeping some metals under their fatigue-limit will allow them to bend back and forth forever.

Members that can bend elastically and at the same time be stiff enough to transmit vibrations may be made relatively long and thin, this will significantly reduce fatigue due to bending, exposing said bending members to tension only (not to compression) will make such longer and thinner bending members possible, this means that vibrating levers, or members, that experience forces (motions) in multiple (possibly opposing) directions may be required to be supported by multiple (possibly opposing) elastically bendable tension members. Said supporting tension members may need to be stiff (i.e. not stretchable, but they may need to be elastically bendable) so that they may transmit the sound vibrations, however whenever there are supporting tension members that oppose each other (i.e. pulling in opposite directions), only one of them needs to be stiff (non-stretch), the other one may even be a compliant spring, as long as it can supply enough force to keep the opposing tension member taut at all times, so that it may transmit the sound vibrations, this is an important point to remember when designing a system with stiff tension members because it allows for a lot more flexibility, e.g. it allows supported members to move in transverse directions.

Implementing strain relief techniques on bending members will help against fatigue too, e.g. like the way an electrical wire joins with its plug, i.e. by making the points on the wire that experience more bending force, harder to bend, e.g. by making them thicker, thus making the bend less sharp, and spreading out the bend over a larger area. Another technique is to position a curved (convex) surface adjacent (always touching somewhere) to the bending member, thus forcing said bending member to bend around said curved surface, thus again, spreading out the bend over a larger area, e.g. thin strips of some iron alloys can bend around a curve with a radius that is a few hundred times greater than the strip's thickness and still remain under its fatigue-limit. The technology behind belts that drive motorcycles may also be useful here. A curved surface may even take the form of a flared sleeve around the bending member, thus allowing said bending member to safely bend in all directions. Conventional spider and surround technologies may also be useful in supporting various vibrating parts.

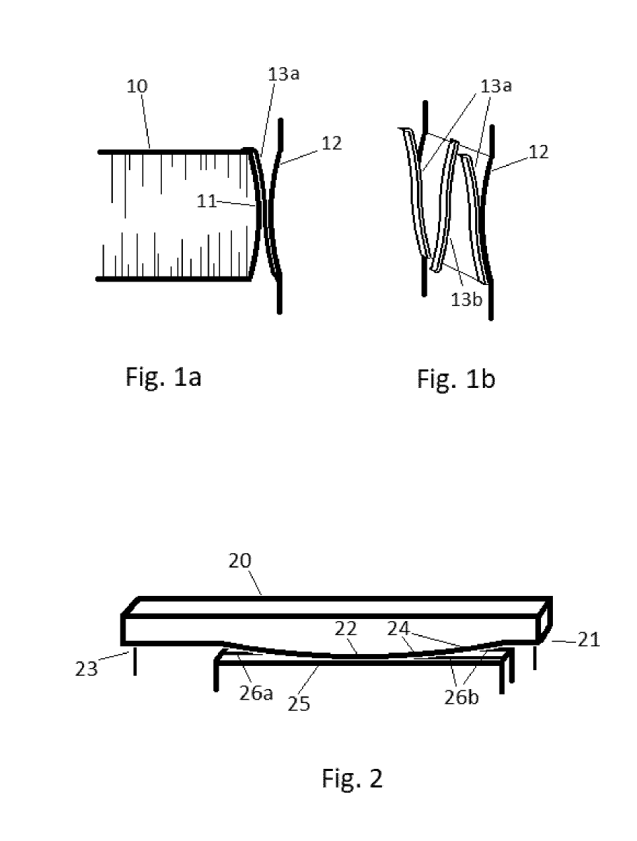

Also (see FIG. 1) a pivoting member or lever 10 may comprise a convex surface 11 allowing it to rock back and forth against a stationary (convex) surface 12 for extra support. Tension members 13a can connect to the top of rocking surface 11 and to the bottom of stationary surface 12, thus keeping surface 11 from sliding upwards on surface 12. Tension members 13b can connect to the bottom of rocking surface 11 and to the top of stationary surface 12, thus keeping surface 11 from sliding downwards on surface 12. Tension members 13 may act as spacers that separate surfaces 11 and 12, or they may sit in shallow channels allowing surfaces 11 and 12 to be in direct contact with each other, note how tension members 13 are kept from overbending by being forced to bend around curved surfaces 11 or 12. Long tension members may connect to almost anywhere on a lever to help keep it in place, or on its path.

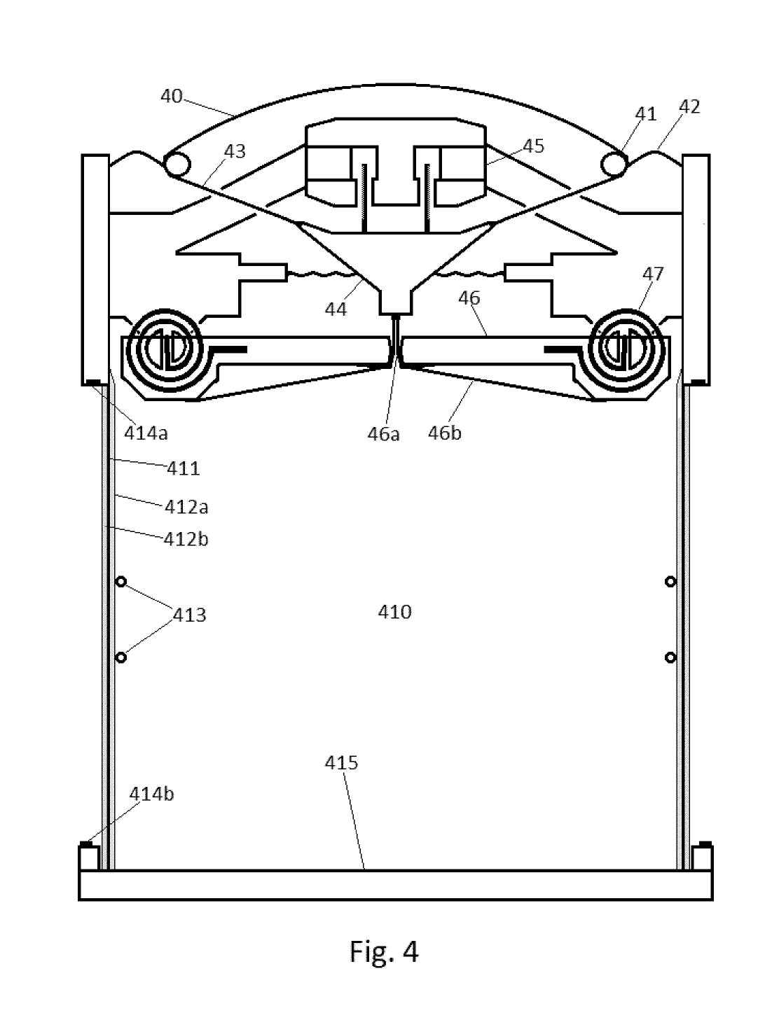

Also, a spring (e.g. 47 as seen in FIG. 4) connected to (one end of) a lever may act as a pivot/hinge, such a spring may be relatively stiff so that it keeps the connected end of the lever relatively still, (it may be combined with another type of hinge if necessary), while the other end of the lever can move quite a bit due to the significant inherent leverage created by the lever (if kept under its fatigue-limit such a spring-hinge may function forever).

Now that we know what our hinges/pivots may look like, we can specify a few very simple mechanisms that can utilize said hinges/pivots, these include a mechanism for transmitting vibrational energy through (stiff) tension members (wires) around turns (note that because of the high stiffness to mass ratio the entire mechanism/system can be much smaller than one quarter wavelength), these also include a mechanism that applies leverage (which can alter the impedance), as well as a mechanism that allows said leverage to be adjustable, either, manually, or automatically.

There are at least two simple ways to transmit vibrational energy, through (stiff) tension members (wires), around turns, one is by utilizing a simple L (or triangular) shaped lever, another is by utilizing a three-tension-member junction (resembling the letter Y), i.e. to design a bend into a tension member (wire), that transmits vibrations, without interfering with said vibration transmission, requires another tension member that spans from said bend, to an unvibratable (i.e. unmovable) member (said unmovable member may be unmovable either, because it has a lot of mass, or because it connects to a common, stiff, framework, where said framework, either experiences equal but opposite forces as well, or where said framework can be considered as the frame-of-reference against which all other motions can be measured, i.e. since we are mostly interested in motions involving the contractions/expansions of the device, i.e. the motion of one part of said device relative to another part of said device, and not in movement of said device relative to its surroundings, we can forgo any concept of absolute rest/motion, note that these definitions of the term “unmovable/unvibratable” can also apply to the fulcrum of the, above mentioned, L shaped lever, as well as to various other specifications herein).

A sharp bend i.e. a bend that is not very obtuse, can warp the sound vibrations if the tension members are not long enough because the angles will be continuously changing due to the vibrations, this will add harmonics to the sound. So multiple, very obtuse, bends (i.e. a series of three-tension-member junctions) can be used instead. Note that the parts of the tension members nearest said junction will be bending back and forth with each vibration, so they should be treated as hinges/pivots as specified above.

There are, at least, two simple ways to apply leverage (perhaps to alter the impedance), one is by utilizing a stiff lever, e.g. using a lever where all forces applied to said lever are by way of bendable tension members, another is by utilizing a three-tension-member junction (resembling the letter Y), i.e. if one of the three-tension-members (wires) is connected to an unmovable member then the leverage ratio between the two remaining tension members will depend on their angles relative to the unmovable (i.e. anchored to an unmovable member) tension member, i.e. the more perpendicular any tension member is to the unmovable (i.e. anchored) tension member, the more relative leverage it will have. Again, long tension members (i.e. many times longer than the vibration size, or the bends, in the tension members, that said vibrations create) will preserve the integrity of the vibrational signal, because it will result in smaller changes to said angles.

Both said techniques of applying leverage can also utilize techniques for making, manual or automatic, adjustments to said leverage, e.g. by utilizing a lever that has parts that can be made longer and shorter, thus resulting in leverage adjustments, e.g. where a part of said lever can pivot on a secondary pivot/hinge that is perpendicular to the main pivot/fulcrum (and who's axle is perpendicular to the lever as well), thus allowing parts of said lever to become operationally shorter and longer, resulting in leverage adjustments, (such a design may put significant perpendicular torque on both pivots, so designing longer pivots/hinges will help, i.e. hinges with longer axles will withstand/resist a greater perpendicular torque), (since the secondary hinge/pivot may not be pivoting with each vibration, but only when the leverage needs adjusting, it may possibly utilize a conventional hinge, but the fulcrum can use multiple long bendable tension members on both ends of its long axle), (note that most references to levers can apply to class a, class b, and class c levers).

Another way to make leverage adjustments is to utilize slidable clamps that can be repositioned along the lever, thus moving the fulcrum, or the other force points, on the lever. Making, manual or automatic, leverage adjustments, when using three-tension-member junctions, can be as simple as moving the unmovable member, thus changing the angles between the tension members, thus effecting a leverage adjustment.

Regarding Shaping Negative Stiffness by Adding Positive Stiffness:

What follows are two general approaches to produce negative stiffness that has a high strength to weight ratio and is also very durable, and at the same time has a nearly constant or desired stiffness vs position graph. The first approach involves adding precise amounts of positive stiffness, where needed, to the negative stiffness to shape its stiffness vs position graph. This is particularly useful if the negative stiffness is produced by magnets, especially attracting magnets. As it turns out, it is easier to shape the stiffness vs position graph of positive stiffness than of negative stiffness. The second approach involves designing precise magnets by including simultaneous equations to attain a desired stiffness vs position graph.

One example of how to add positive stiffness is to use repelling magnets, e.g. a small repelling magnet with a strong but small magnetic field (where the repelling field only kicks in when the magnets are very close) can cancel the upward spike in the negative stiffness vs position graph of attracting magnets due to the invers square law. See below for how to use simultaneous equations to precisely shape and position a magnet.

Another example of how to add positive stiffness is through the use of varying leverage. It is easier to produce types of positive stiffness, for audible frequencies, through the use of varying leverage, than it is to produce negative stiffness, e.g. positive stiffness can be produced using varying leverage that is produced by tension members alone, e.g. a three wire junction resembling the letter ‘Y’ as described in the Prerequisite specifications section above, if one of the three wire ends is anchored to an immovable object, and another end is tied to an infinitely compliant spring, the third end would still exhibit positive stiffness, i.e. someone pulling on the third end will feel it getting harder, and not easier, as he progresses.

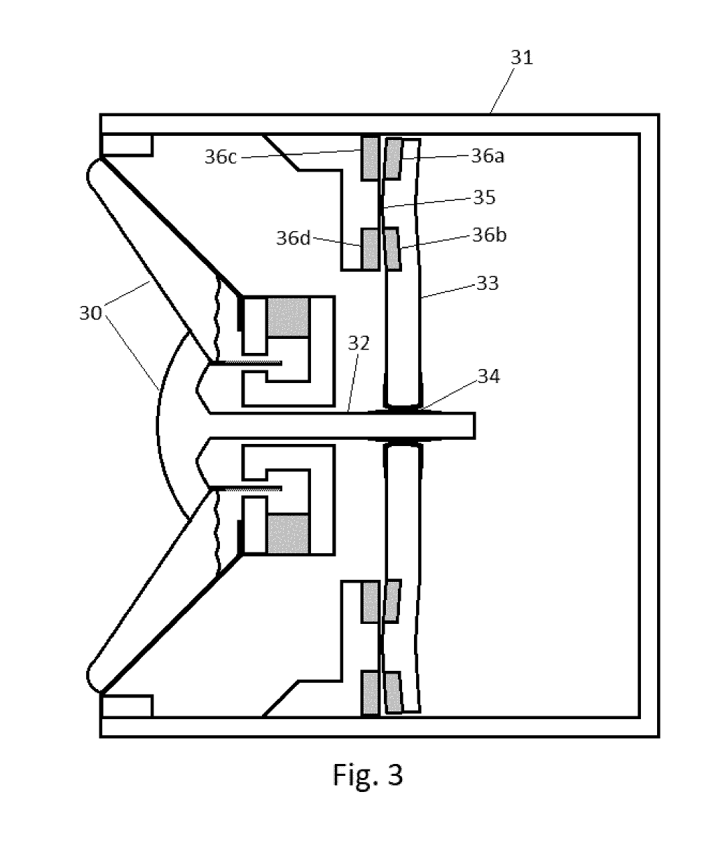

Another example of how precise amounts of positive stiffness, through varying leverage, can be added more easily than negative stiffness, is a lever 20 (see FIG. 2) that connects to any of its force-points (effort 21, fulcrum 22 or load 23) by way of a rocking convex surface 24, e.g. the way the bottom of a rocking chair may connect with the floor. Such a rocking motion between two touching surfaces 24 and 25, where at least one surface is convex, allows for a contact point 22 (effort, fulcrum or load), or line 22, that can move, thus creating varying leverage, what's more, said contact point 22 can move significantly faster than any of the physical parts, so it is not limited by the effects of inertia at audible frequencies so it can be made heavy and strong, however this can only add positive stiffness, not negative stiffness, unless said surfaces 24 and 25 can attract each other where they touch 22, perhaps magnetically or through cohesion or localized suction (thus allowing said force-point 22 to apply tension rather than compression), note that this is yet another way to achieve precise negative stiffness for audible frequencies.

A rocking lever 20 utilizing a precisely curved convex surface 24 can add precise amounts of positive (or even negative) stiffness where needed, thus precisely shaping a negative stiffness vs position curve. In the acoustic products described below said rocking lever may connect the diaphragm to the magnet(s), or even to a (high compliant) spring that pulls/pushes alongside (or even against) the magnet(s).

To figure out the shape of the convex curve 24 that we need, where a rocking lever 20 comprises said convex curve 24, and sits on a flat horizontal surface 25, and the point of contact 22 between said convex curve 24 and said flat surface 25 serves as the current fulcrum position, we decide where the next fulcrum position needs to be by deciding how much the force needs to change when the lever rotates by say 0.01 degrees on the current fulcrum 22, we then know the new force ratio between the effort 21 and load 23, so we know where the horizontal position of the next contact point (fulcrum) 22 needs to be, and we can assume that its vertical position is slightly above the flat surface (so that the angle between the flat surface 25 and a straight line connecting the two points (fulcrums) 22 and 22′ on the curved surface 24 is half of the said 0.01 degrees), we can then rotate the lever 20 by the said 0.01 degrees, and keep repeating this process until the curve 24 is fully mapped out. Since no surface is infinitely hard, the contact points won't be infinitely small, so some averaging, and even some type of simultaneous equations, may be helpful. Similar to tension members 13 in FIG. 1, tension members 26 can connect the far ends of surfaces 24 and 25 to keep them from sliding on each other.

Magnets needed to produce negative stiffness for some applications may have too much mass, e.g. if such a magnet is connected to the diaphragm of an acoustic product its mass may keep the diaphragm from vibrating as much as is necessary for that particular product, additionally, if the magnet is connected to the diaphragm through a lever who's leverage varies with position it can make the diaphragm behave as though it has mass that varies based on its position, this may affect the sound quality, e.g. it may create harmonics. A solution to both these problems is to lower the leverage of the magnet(s), e.g. if the lever's (moving) fulcrum is positioned closer to the magnet(s) than to the diaphragm, so that the magnet(s) doesn't need to move as much as the diaphragm, this will limit the effects of the magnet's mass on the diaphragm, this will mean that the magnet(s) has to pull harder, but over a shorter distance, so the potential energy and therefore the total mass of the magnet(s) need not change, it just needs to be shaped differently, or be a few small magnets instead of one big one, e.g. to create a strong force over a short distance many small or narrow magnets may be used (instead of one big one), for this to work, these small, or narrow, magnets need gaps between them (so that they don't behave like one big magnet), or they need to be positioned at alternating angles, e.g. a Halbach array, we can always reshape their negative stiffness by adding positive stiffness.

Another solution to the varying mass problem (i.e. the second problem) may include adding additional levers that comprise moving fulcrums, possibly pushing/pulling in the opposite direction, and additional masses, that may be magnets, that can counterbalance the effect of said first varying mass, while all together producing the desired stiffness. Of course, if the magnets on their own are designed to have relatively accurate negative stiffness (see below for how to use simultaneous equations to precisely design accurate magnets), the rocking levers won't need to vary the leverage by much and the varying mass may be negligible. One advantage of using levers that comprise moving fulcrums (as opposed to using precise magnets) is that they may more easily be adjusted, reshaped, or replaced, than magnets.

All techniques, described in this document, for achieving nearly constant or desired negative stiffness may also be useful in other applications, for example to cancel stiffness in automobile suspension systems, or isolation tables, or other vibrating or non-vibrating systems, etc.

Regarding Shaping Negative Stiffness by Designing Accurate Magnets:

Although it is possible to create an almost constant negative stiffness vs position graph by using magnets that are many times bigger and heavier than would otherwise be necessary, so that only a very small percentage of the magnets' potential energy would be utilized, for example, if two magnets apply 10 kg of attractive force on each other at a distance of 10 mm, but only 9 kg at 11 mm, such a 1 kg drop could be relatively constant.

However to create an almost constant negative stiffness vs position curve, without the use of such powerful and heavy magnets, requires a rethink, because magnetic poles follow the inverse square law (and if the two poles of a given magnet are relatively close to each other it may even follow the inverse cubed law, because the poles cancel each other), which is very nonlinear, and if one of the magnets is replaced with a ferrous material it will become even more nonlinear (this is because the ferrous material becomes more magnetized as the magnet approaches it), another problem with ferrous materials is that hysteresis may add nonlinearity, so soft ferrous material, or materials used in balanced armatures, may be more desirable. Some magnets may also have some of said properties of ferrous materials, so magnetic materials that are used in higher quality speakers may be more desirable.

So to create an almost constant negative stiffness vs position curve we must rely on the fact that as the magnets come closer to each other, at least, some parts of said magnets start pulling sideways, or even backwards, on each other instead of forwards, thus losing forward strength and canceling the sharp upward stiffness curve due to the invers square law.

To figure out what the exact shape, and orientation, the magnets need to be, we can start by studying the ampere-model of magnets, as well as the gilbert pole-model, both said models tell us that a magnet can be thought of as being comprised of many smaller parts (either dipoles or individual pole charges), and the effects of distance and spatial orientation on the magnetic force vectors of said smaller parts are well known, it is therefore possible to utilize simultaneous algebraic equations to come up with an exact design for our magnets.

One example of said simultaneous equations takes the magnetic pole charge strengths, of the individual magnet voxels, as the unknowns, and the potential forward attraction and repulsion factors between voxels, due to their distance and orientation from each other, as the coefficients (i.e. the distance's forward-vector-component divided by (distance to the third power)). And the value on the other side of the equals sign is the desired forward attraction of the entire magnet(s) at a specific distance (where distance is defined by said coefficients) (note that the term forward means forward along the allowable travel path of the movable magnet, which may NOT be directly towards the attracting magnet, long flexible but stiff-against-tension tension members may keep such a magnet on its path, a second similar but reversed (mirror image) pair of magnets arranged to pull in the opposite sideways direction may also help).

The following is one example of a simple way of creating a desired negative stiffness vs position curve using simultaneous equations, we start with magnets that are shaped like cylinders, each flat side is a magnetic pole, one of these cylinders having a diameter that is perhaps twice as great as that of the other cylinder, (the symmetrical shape of these magnets will allow us to use less voxels in our equations), additionally, these magnets have all their internal dipoles lined up evenly in straight parallel lines that are normal to the flat surfaces (poles) (these dipoles need not be individual atoms, they just need to be small enough not to make a practical difference), such dipole arrangements may be achieved by placing them (while hot) in magnetic fields consisting of very straight and parallel field lines, while completely filling the space in (if the magnets have holes) and around them with similarly permeable material, so that the magnetic field lines aren't affected by boundaries and such.

We can deduce from the ampere-model of magnets that such lines of identically oriented dipoles can be thought of as a unit of north magnetic charge on one end of each of said lines and a unit of south magnetic charge on the opposite end of each of said lines, so since these lines are evenly distributed, and they all end at the flat surfaces (poles) of the cylinders, the magnetic pole charges will be evenly distributed on said flat surfaces, this makes our simultaneous equations simpler, because we need not concern ourselves with all the voxels comprising the three dimensional space of the magnets, instead we need only concern ourselves with the pixels that make up the two dimensional space of the flat surface poles, and we can now use the gilbert pole-model.

We now position these two magnets so that the north pole of one is exactly facing the south pole of the other, so that the axles of both cylinders fall on a single line (i.e. so that they are both lined up and centered), we now imagine that the larger cylinder is made up of many coaxial tubes inside of one another, the ends of these tubes appearing as concentric circles that make up both flat surface poles. This symmetrical arrangement now allows us to represent each said tube by only two pixels, because we know that for any single tube the forward force exerted (by both poles of the smaller magnet) on all north pole pixels are equal, and the same is true for the forward forces exerted on all south pole pixels of any single tube.

But before we can begin our simultaneous equations we need to figure out the coefficient for each tube, in each equation, we do this by summing up the forward vector component of the magnetic fields, at the locations of one of said tube's north pole pixels and one of said tube's south pole pixels, due to all (again using the gilbert pole-model) magnetic charges on the smaller magnet, this is relatively easy with a computer, since said charges are evenly distributed on the two flat surface poles, and considering the inverse square law, we just multiply the unit charges by the distance's forward-vector-component divided by distance-to-the-third-power, (if we want the coefficient to represent the whole tube, rather than just one north pole pixel and one south pole pixel of said tube, we could, of course, multiply by the number of pixels on the poles of said tube). And we repeat this process for every position of the moving magnet along its traveling path, this gives us all the coefficients for all the equations.

Again, the values on the other side of the equals signs are the desired forward attraction of the entire magnet(s) at specific distances (where distance is defined by the coefficients). The simultaneous equations will give us the unknowns, which correspond to the charges on each tube. We can remove charge from tubes by removing physical mater from the tubes, we should remove this matter in longitudinal strips that run the length of the tubes, this way we avoid creating new poles, this may be done by creating oddly shaped radial cuts in the cylinder (since these oddly shaped cuts run in straight lines from north to south they can be easily made, and easily filled during magnetization). We may avoid cutting by using proper molds and casts.

To give us better precision, we can cut the large cylinder into multiple short cylinders, where the tubes start to look more like rings each having a north and south pole, and then do said simultaneous equations using these rings, but these cuts may have to be physical (rather than just imaginary) so that we can get to the rings to remove matter from them, we can then glue the short cylinders back together again to make one large magnet. The cuts in the larger cylinder may be simpler if the smaller cylinder had a hole in the center, i.e. we imagine that the smaller cylinder is also made up of coaxial tubes and we remove a few of said tubes from the center. It may also be advantageous if the flat surface (pole) of the larger magnet curves inward (concave like) so that it can partially wrap around the smaller magnet, possibly resulting in some parts of the magnets pulling backwards on each other.

Since these magnets rely on sideways forces, the magnets may want to shift sideways, we can somewhat solve this problem by giving the magnets mirror sideways symmetry, but that may result in sideways equilibrium that is unstable, e.g. like a pencil balancing on its tip, so some system/mechanism may be necessary to keep the magnets from shifting sideways relative to each other, said system/mechanism may need to hold both poles of the stationary magnet(s), or of the moving magnet(s), or of both magnets, from moving sideways. This task may be doable using magnets as well, but it's more easily doable using a stiff structure that may include long tension members, that have high tension-stiffness, that are perpendicular to the magnet's path of motion, to hold the moving magnet from moving sideways while allowing it to move backwards and forwards. Although the diaphragm of an acoustic product may itself serve part of this function, it will require that the diaphragm be stronger and stiffer than it otherwise needs to be, because to serve this function the diaphragm may have to be relatively flat despite the air pressure that is forcing it to bow.

Although attracting magnets may have some advantages over repelling magnets, similar simultaneous equations can be used on both, since even attracting magnets have parts that repel, and vice versa, and since simultaneous equations work just as well on positive numbers as they do on negative numbers.

Regarding Speakers with Negative Stiffness:

In consideration to what was brought up in the “background” section, FIG. 3 shows a cross section of one variation of one embodiment of a (sub) woofer that uses one variation of negative stiffness disclosed herein, it comprises a driver 30 and enclosure 31, the driver 30 looks like a standard driver except that it comprises a stiff light-weight rod 32 that passes through the center of its magnet and connects to its diaphragm, the other end of rod 32 connects to a plurality of rocking levers 33 by way of tension members 34 (similar to FIG. 1, except that surface 12 is flat), levers 33 comprise curved surfaces that act as moving fulcrums 35 (this adds the necessary positive stiffness), they also comprise two magnets 36a and 36b that attract adjacent magnets 36c and 36d respectively (this produces negative stiffness), note that each of these magnets 36 may in reality be an arrangement of a plurality of smaller or narrower magnets, e.g. they may comprise Halbach arrays. As the diaphragm and rod 32 move forward the attractive force between magnets 36b and 36d become stronger thus producing a forward force on the diaphragm, and as the diaphragm and rod 32 move backward the attractive force between magnets 36a and 36c become stronger thus producing a backward force on the diaphragm. The two touching surfaces that make up a moving fulcrum 35 can be connected to each other by (perhaps four) tension members (similar to FIG. 1, except that surface 12 is flat). The levers 33 may be very wide, and if the lever width is tapered as it approaches rod 32 there may be room for many wide levers on a single plane.

The levers 33 serve here a dual purpose: 1 they each comprise a moving fulcrum 35 that adds positive stiffness where needed, 2 fulcrum 35 tends to be a lot closer to the magnets 36 than to the end of the lever that connects to the diaphragm, this keeps the mass of the magnets 36 from being transferred onto the diaphragm (and since the potential energy demand on the magnets 36 is not affected by this, the total mass of the magnets 36 need not change), so even if we don't need to add positive stiffness, a simple lever with a fulcrum that is closer to the magnets than to the diaphragm can be very helpful.

In another embodiment levers 33 may each comprise only one magnet (group) instead of the two, and another set of levers may pull rod 32 in the opposite direction.

A (sub) woofer using negative stiffness has some of the same issues as the other acoustic products that use negative stiffness have, as explained later in this document, some of the other patents mentioned in this document suggest some possible solutions to some of these issues, these issues include the instability of the diaphragm, and solutions are given later in this document in the section pertaining to sound absorbers or blockers that utilize negative stiffness (so the accompanying drawings are not necessarily complete). The negative stiffness can also have a negative effect on sound quality so servo control can be very helpful.

Regarding Speakers Comprising a Non-Stretch Layer:

In consideration to what was brought up in the “background” section, FIG. 4 shows a cross section of one variation of one embodiment of a (sub) woofer that uses non-stretch, airtight, layers that are held taut by air pressure, e.g. the average air pressure in the enclosure 410 may be 1 Psi higher than outside. The diaphragm 40 comprises such a taut layer 40 surrounded by a light-weight (possibly hollow) ring 41 that has high compression-stiffness, this ring 41 keeps the tension off of the surround 42, tension members 43 connect the ring 41 to the vibrating-hub 44, said hub 44 holds the voice-coil inside the magnet 45, hub 44 may be supported by a spider, hub 44 connects to spring-loaded light-weight levers 46 by way of tension members that curve around the slightly convex ends 46a of levers 46, tension members 46b help reinforce the light-weight levers 46, the leverage created by levers 46 makes springs 47 appear much less massive and much more compliant (the effects of leverage on apparent mass, and apparent compliance, is much greater than its effect on force) this will allow springs 47 to actually be quite stiff, this spring stiffness will eliminate the above mentioned echoes, this spring stiffness will also allow the springs 47 to double as hinges, e.g. the springs 47 may be the only thing (firmly) holding that end of the levers 46 in place. Replacing the metal springs with a properly compliant air-spring may also resolve the “echoes” problem without the need for levers (because of its lighter weight, and also because air can have more symmetry than a metal spring). Instead of a spring, an added dc current through the voice coil may also center the diaphragm, To save energy, the amplitude of this dc current may decrease (over a few seconds) as the amplitude of the ac current decreases, this means that the internal air pressure may be controlled by said current, so an air pump, used to add air to the enclosure 410, may choose to turn on or off based on the average position of the diaphragm.

The enclosure 410 has walls comprising a non-stretch, yet very flexible, layer 411 (as explained later). The enclosure's walls also comprise an airtight layer 411, this layer may be one with the non-stretch layer 411 or it may be supported by the non-stretch layer 411. To minimize vibrations, the enclosure 410 is in the shape of a cylinder, and the diaphragm 40 is radially centered on that cylinder (so that sound waves generated off the back of the diaphragm 40 will always apply equal pressure to all points on the enclosure's walls that lie on a single plane, where said plane is parallel to the flat sides of the cylinder) so that the enclosure's non-stretch but flexible walls 411 will not move when hit by any internal soundwaves (this is important because the internal soundwaves are a lot more concentrated than any external soundwaves). The enclosure's walls may also comprise inner layers 412a and\or outer layers 412b, these layers 412 may help keep the non-stretch layer 411 from folding sharply and creasing, they may also add some damping. Flexible, and possibly stretchable, tension members crisscrossing the enclosure 410 and interconnecting the enclosure's walls may also add damping if necessary.

Weak rubber bands 413 surrounding the enclosure 410 can pull its flexible walls inward when “deflated”, allowing snaps, clips or magnets 414 to easily connect the disk-shaped unbendable wall (floor) 415 of enclosure 410, to the speaker driver section, resulting in a relatively small container that can easily be stored or easily be carried by a handle. A small quiet (insulated) air pump(s) (not shown) may reside between the levers 46 or lever support structures, e.g. between the springs 47, and to protect the voice coil from damage the speaker may not be allowed to reach full sound volume until fully pressurized, and the air pump may turn off once fully pressurized, and it may comprise a valve that may be opened manually or automatically for deflation. The disk-shaped wall 415 may be replaced by a second speaker driver section (assembly) facing, and vibrating, in the opposite direction, this can significantly decrease the vibrations of a light-weight enclosure. Legs, or some kind of a base, can be added almost anywhere to make this speaker stable in any particular orientation. If a diaphragm is facing downward, said legs, or base, may need to be longer to leave a reasonable amount of space between said diaphragm and the floor. Servo control can benefit this speaker as well.

Most solid materials, like plastics, if they are highly non-stretch (having a high Young's modulus) will not be very flexible and they will crease easily. One solution to this problem is to use spun thread, spun thread has the ability to be very stiff (very non-stretch) yet remain very flexible, this is true not only because it is made up of thinner fibers/filaments, but also because the alternating positions of these fibers/filaments means that when the thread is wrapped around a circle, there are no fibers/filaments that are always on the outside or always on the inside of said circle, i.e. no fibers/filaments are forced to become longer or shorter, and any force is still distributed equally amongst the fibers/filaments.

Other ideas include: 1) an enclosure wall or diaphragm comprising stiffer sections separated by more flexible sections so that any folds will inevitably occur in the flexible sections, e.g. a wall comprising stiffer two inch squares separated by 0.25 inch, more flexible, borders, 2) an enclosure wall or diaphragm comprising a stiffer layer 411 and also comprising at least one adjacent layer 412 to help keep the stiffer layer 411 from folding sharply and creasing, 3) a less stiff substance or a less stiff plastic may also work, simply making it thicker will make it less stretchable. The bulk modulus of the enclosure, if the diaphragm(s) was not allowed to move relative to the enclosure, should be, perhaps, five, ten, or more (more is better), times greater than the bulk modulus of the air that fills the enclosure, so we can figure out the enclosure's wall thicknesses by using basic math once we know the remaining dimensions and the Young's moduli of the walls and parts that make up the enclosure.

Aramid has a very high Young's modulus (according to sources on the internet), but it may still be necessary to do some testing, since the threads may be spun and interlocked with transverse threads in a woven fabric the compressibility of the adjacent fibers may interfere with the tension stiffness, so some testing may include a tight weave vs a loose weave vs no weave, and possibly the ratio that the threads are spun, and to see how much tension the threads need to be under before the desired stiffness kicks in. A layer like aramid may be coated with an airtight layer.

Since the enclosure 410 is cylindrical in shape its flexible non-stretch wall 411 can easily be made from a single piece of woven aramid, or fabric, that wraps all the way around said cylinder, and for best results its threads can run both parallel and perpendicular to the cylinder's axle. However, to create a dome shaped diaphragm 40 from flexible woven material may be much harder. Some materials that comprise spun thread may be pressed into a dome shape. Another solution is to create a diaphragm that is not very flexible, perhaps from plastic, another solution may be to create the dome from many woven patches, they may be sewn and/or glued together, however the orientation of the threads may be important, so one solution is to create many long isosceles triangles (shaped like a pie cut into a dozen slices) where the threads are both parallel and perpendicular to the base of each triangle so when all these triangles are sewn or glued together to create a dome the threads will be laid out both radially and concentrically (coaxially). Before combining these long triangles, each triangle may also be cut crosswise (parallel to the base) making it into a few short pieces. There may be lots of overlap between all the pieces/patches that make up the dome for easy stitching and/or gluing. Gluing threads to perpendicular threads may also help distribute the forces. Since the glue itself doesn't span large gaps the glue itself doesn't have to be of a stiff nature. The surround 42 too can be made very light weight and flexible since it too can be held taut by the air pressure, this may improve the sound quality since parts of a conventional surround may be forced to move in a nonlinear manner during large diaphragm displacements.

Regarding Speakers that Combine Negative Stiffness and a Non-Stretch Layer:

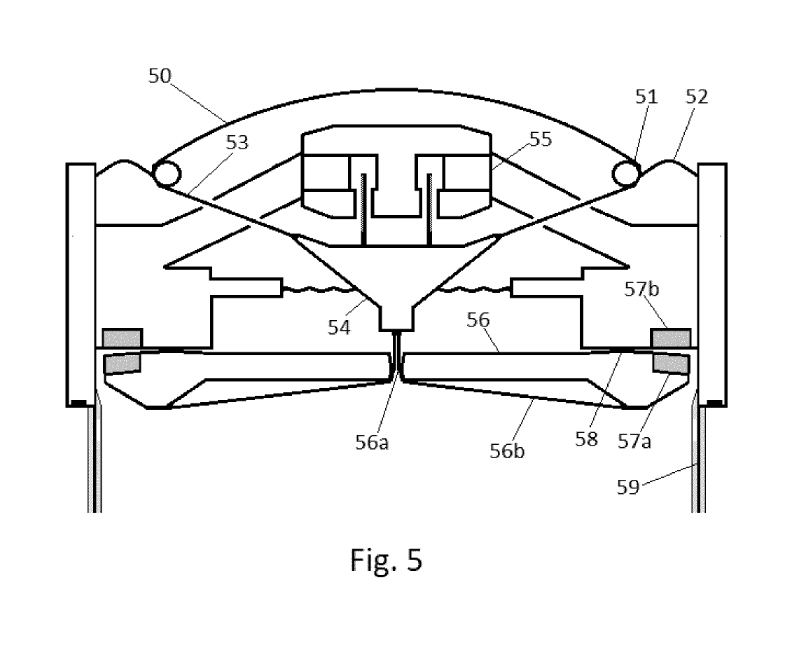

FIG. 5 shows a cross section of a speaker (perhaps a subwoofer) that combines some of the features of FIG. 3 with some of the features of FIG. 4. The diaphragm comprises a non-stretch taut layer 50 surrounded by a light-weight (possibly hollow) ring 51 that has high compression-stiffness, this ring 51 keeps the tension off of the surround 52, tension members 53 connect the ring 51 to the vibrating-hub 54, said hub 54 holds the voice-coil inside the magnet 55, hub 54 may be supported by a spider, hub 54 connects to a plurality of light-weight levers 56 by way of tension members that curve around the slightly convex ends 56a of levers 56, tension members 56b help reinforce the light-weight levers 56, levers 56 comprise curved surfaces that act as moving fulcrums 58 (this adds positive stiffness), they also comprise a magnet 57a that attracts adjacent magnet 57b (this produces negative stiffness), note that each of these magnets 57 may in reality be an arrangement of a plurality of smaller or narrower magnets, e.g. they may comprise Halbach arrays. The leverage created by levers 56 makes magnets 57 appear much less massive (the effects of leverage on apparent mass is even greater than its effect on force), and since the leverage does not cause changes in potential energy it does NOT cause a need for more massive magnets.

The enclosure is pressurized to keep the light weight diaphragm taut, the enclosure, however, may be collapsible as in FIG. 4, or may not be collapsible as in FIG. 3. See the previous sections for more details.

A (sub) woofer using negative stiffness has some of the same issues as the other acoustic products that use negative stiffness have, as explained later in this document, some of the other patents mentioned in this document suggest some possible solutions to some of these issues, these issues include the instability of the diaphragm, and solutions are given later in this document in the section pertaining to sound absorbers or blockers that utilize negative stiffness (so the accompanying drawings are not necessarily complete). The negative stiffness can also have a negative effect on sound quality so servo control can be very helpful.

Regarding Sound Absorbers and/or Blockers that Utilize Negative-Stiffness:

Sound absorbers and\or reflectors (blockers) that use negative stiffness (similar to those described in the Chinese patents, see the “background” section) are described here as Passive negative stiffness devices (PNSD) even though they may comprise a secondary active mechanism as described below. Although this section refers mostly to Passive negative stiffness devices (PNSD) (i.e. sound absorbers and\or reflectors (blockers) that use negative stiffness) much of it can also apply to speakers that use negative stiffness, one difference between PNSD and said speakers is that a speaker's diaphragm is moved mainly by a voice coil whereas the PNSD diaphragm is moved mainly by external sound based pressure changes, anther difference is that the PNSD may have a diaphragm displacement that is an order of magnitude smaller than the speaker, and since diaphragm displacement squared equals potential energy, which equals magnet mass, PNSD magnets may weigh next to nothing.

PNSD (used to absorb and/or reflect lower frequency sound) that are more than just twenty or thirty percent more compliant than regular air, will benefit greatly from a simple, relatively slow acting, secondary mechanism that acts to keep the negative-stiffness elements (magnets) within their operational (functional) range despite barometric and altitude and temperature changes and possible small air leaks which can cause large undesirable diaphragm displacements, that will coincide with relatively large undesirable pressures, internally, as well as on the negative-stiffness elements (which in the above mentioned Chinese patent embodiments happen to be magnets—but they don't have to be). E.g. a passive negative stiffness device (PNSD) that has ninety percent of its internal air stiffness canceled by negative stiffness, will be ten times more compliant than air, and will have a volume change of, around, twenty percent in response to a two percent barometric shift, this corresponds to an eighteen percent shift in the internal relative air pressure, this will put a very high demand on the negative-stiffness elements (magnets). In contrast, air pressures resulting from a very loud 130 dB sound correspond to less than one tenth of one percent of an atmosphere.

Note that even if the barometer and temperature are held constant and there are no air leaks in the PNSD, this, relatively simple, secondary mechanism will still be necessary in substantially compliant devices because adiabatic air is stiffer than isothermal air, which means that the air will exhibit more stiffness in response to quick (adiabatic) pressure changes than it will to slow (isothermal) pressure changes, so the negative-stiffness elements that are designed to cancel most of the air's quick (adiabatic) stiffness will overwhelm the air's slow (isothermal) stiffness, causing the diaphragm to exhibit, slow, instability that require regular adjustments, somewhat similar to the adjustments one needs to make when balancing a relatively long stick on one's finger (for example, when the chamber expands even ever so slightly, the internal temperature drops ever so slightly, so the chamber starts pulling a slight amount of heat from the outside, this additional slight amount of heat will cause a negative stiffness chamber to expand quite a bit more, again making the chamber even colder, this is a runaway effect, so just like when one is balancing a stick on one's finger, when one see it start moving in either direction one needs to respond without delay, so it may help to keep track not only of its position but also of its movement. Sometimes one may want to expand the chamber a little (e.g. to counteract the effects of barometric change or temperature change), so one may add a drop of air, or move a wall slightly inward, but now the diaphragm moves forward and the chamber becomes colder, and as long as the chamber is colder it will keep pulling in heat, and expanding, so one may have to keep compensating by repeatedly shrinking the chamber until the temperature evens out, alternatively one can help the heating process along with a little heating element, or by overshooting the target at first).

Thermally isolating the air in the chamber as much as possible will make the system more stable (the equivalent of making said balanced stick, longer), so a radiation-reflecting layer enclosing some, or all, of said air, can help, and an insulation layer enclosing some, or all, of said air can help. It will help if the side of the insulation that is in contact with said air be very light so as not to transfer its own heat into said air. Ideally the air trapped in air pockets in the insulation should always be the same temperature as the insulation, i.e. any heat exchange between the two should happen instantaneously so that even the quicker audible pressure changes be isothermal, this means that said air packets be very small, perhaps no bigger than 0.2 mm. A lighter insulation can have more air pockets rather than larger air pockets.

Such a secondary mechanism may need to be active, i.e. have a power source, but considering that it can make a three cubic foot bass trap/resonator be as effective as a thirty cubic foot bass trap/resonator, and it can make a four inch, isolating, gap between two walls be as effective as a forty-inch gap, perhaps on aircraft, can make it well worth it. Such a secondary mechanism may run somewhat slowly so that it doesn't compensate for twenty Hz pressure changes as it does for a barometric change, but it may be beneficial if it runs continuously, because the longer it waits between corrections the more power it will consume, it may also be beneficial if the speed at which it runs depends on the size of the error needing correction, it may also be beneficial if the speed at which it runs can only change gradually. There are many, possible, practical, slow-mechanism designs for keeping, low-force negative stiffness elements, within their functional range, despite slow, but forceful, events, like barometric change. Most of these mechanism designs will have various side effects, but most of these side effects will be good, like, keeping any diaphragm displacements within a functional range, some will affect not only the forces but also the stiffness, this, too, is advantages for maintaining a constant resonant frequency despite temperature, and barometer, changes.

Said mechanism should keep track of where within its functional range the negative stiffness element is, it can do so by, either, tracking the force on said element (perhaps by using a scale), or by tracking the length of said element (perhaps by using proximity sensors), said tracking method may also be very indirect, e.g. measuring, both, the external air pressure (barometer), and the internal air pressure, may be enough to know the force on the negative stiffness elements, There are several, practical, general approaches for said mechanism, these can involve making direct adjustments to the trapped air inside the chamber, as well as, making direct adjustments to the solid matter that composes the chamber. Making direct adjustments to said air can involve adding/removing air to the trapped-air chamber (perhaps through the use of an automated air valve or pump), also, adding/removing heat can have the same effect, note that these actions will have a counterintuitive effect, e.g. adding air will create a pressure drop, because it will cause a disproportionately large outward movement of the diaphragm, and therefore a disproportionately large increase in chamber volume.

Making direct adjustments to the solid matter that composes the chamber can involve changing the size of the chamber, perhaps by moving one of its walls in and out, or by moving the fixed ends of the negative-stiffness elements (which, in the above Chinese patents, is the fixed magnet that is attached to the container (base)) in and out (and since the negative stiffness elements are attached to the diaphragm and the diaphragm serves as one of the chamber walls, it is somewhat similar to moving a chamber wall in and out), note that said movements will have a counterintuitive effect, i.e. moving a chamber wall, or the fixed end of the negative stiffness element, inwards (as in trying to shrink the chamber) will cause an internal pressure drop, because it will cause the diaphragm to move significantly outwards, thus enlarging the chamber.

To help make sense of this it helps to keep the following in mind: (for the sake of simplicity let's assume that, due to sound, the air chamber only contracts/expands by a fraction of 1% and that the air's stiffness can be thought of as being practically constant throughout that range) the internal air volume's positive stiffness has a (stable) position of equilibrium (this equilibrium position is simply where the chamber size (which is defined by the positions of the walls, as well as the position of the fixed end of the negative stiffness element (e.g. the fixed magnet)) as well as the internal air mass is such that the internal air pressure is equal to the external air pressure), and the negative stiffness mechanism (e.g. the magnets), also has an (unstable) position of equilibrium, (this equilibrium position may not actually exist, it's theoretically located where the magnetic attraction would drop to zero, not all magnet arrangements are designed to cross the zero-position). By making any of the above described adjustments the distance between said positive stiffness equilibrium position and said negative stiffness equilibrium position is adjusted, and in a system where the negative stiffness is ninety percent as strong as the positive stiffness (i.e. where ninety percent of the air stiffness is canceled), if the distance between positive equilibrium and negative equilibrium is one unit (regardless of unit size), then the equilibrium position of the final product, i.e. the size of the air chamber at rest, will be 9 units away from the former and 10 units away from the latter, because that is where their forces are equal but opposite.

Making direct adjustments to the air alone (e.g. adding or removing air), when compensating for barometric change, can have a significant effect on the resonant frequency of a sensitive PNSD, e.g. a slight increase in barometer will cause the diaphragm to move significantly inwards, so to compensate, an equally slight amount of air can be pumped into the chamber bringing the diaphragm, and therefore the negative stiffness elements, back into position, but now the internal air pressure is, still, slightly higher than before, and since for a gas of a given volume, pressure and stiffness are corelated, the internal air stiffness will be slightly higher as well, this difference may only be five percent, but after the negative stiffness cancels ninety percent of said air stiffness, this five percent will become fifty percent. So, to maintain a constant resonant frequency, as the barometer goes up, adjustments to the solid matter of the chamber can be made, e.g. that will result in a larger chamber, because a larger chamber, holding a larger body of air, is more compliant.

Another possible way of making direct adjustments to the, said, solid matter, can involve making leverage adjustments between the negative stiffness elements and the diaphragm, e.g. by utilizing tension members extending from the negative stiffness elements, and tension members extending from the diaphragm, it is possible to create a leverage adjusting mechanism as specified above. Leverage adjustments affect stiffness (change in force divided by change in position) significantly more than they affect force itself, so it is possible to algebraically isolate stiffness by making leverage adjustments while simultaneously making adjustments that compensate for changing force, e.g. making an adjustment that will cause a slight change in the distance between the magnets. Such stiffness adjustments can control the resonant frequency.

When the negative stiffness element(s) and the diaphragm are connected through a lever, moving the fulcrum, of said lever, along a line that is parallel to the force vectors, is operationally equivalent to moving the fixed end of the negative stiffness element, i.e. it will have the same net effect, (note that most references to levers can apply to class a, class b, and class c levers).

PNSD can either be designed with an air chamber who's pressure is always above atmosphere, or always below atmosphere, or around (sometimes above and sometimes below) atmosphere, the advantage of the former two is that the diaphragm can be light and flexible and still never lose its shape (because it's being supported be the air pressure difference), another advantage is that its negative-stiffness elements never need to cross the zero-force position (to cross the zero-force position may require another magnet pulling in the opposite direction, though even a weak compliant spring pulling in the opposite direction can also cause the negative stiffness to cross the zero-force position), the advantage of the latter is that chamber size adjustments alone (e.g. moving one of the chamber walls in or out or moving the fixed end of the negative stiffness element (which in said Chinese patent is the fixed magnet) in or out) can serve to force air, both, in, and out, of the chamber through tiny openings, thus allowing the diaphragm, as well as the negative stiffness elements, to stay within range despite slow air leaks and barometric changes etc. These same ideas can also be applied to speaker enclosures

So one embodiment of a PNSD that includes advantages of all of the above embodiments, comprises an air chamber who's pressure is always above atmosphere, and where said air chamber is connected to a second, similarly, pressurized, air chamber, by way of a very small opening that allows only a slow trickle of air between them, this second air chamber can serve as an air reservoir, but it won't affect the short term (20 Hz) air stiffness in the primary chamber due to the very small opening between them, this secondary chamber may be expandable/contractible, perhaps utilizing a low-stiffness spring allowing it to always maintain a pressure that is slightly above atmosphere, it may also include an automatic pump to replenish any air lost over time.

One, said, secondary chamber may be shared by many PNSD, e.g. a tube from said secondary chamber can connect to many nearby PNSD, and small openings into every PNSD will limit the airflow. A shared secondary chamber can be very useful when many small PNSD are positioned between wall surfaces/panels to form a, relatively light, wall that blocks low frequency sound (see sound blocking section in “background”), this may be very useful on aircraft.

The diaphragms of the many PNSD inside of said wall, may, or may not, be one with said wall surface/panel, for example if there are air gaps between said PNSD devices that also need a sound pressure relief outlet, then keeping the diaphragm separate from the wall will be beneficial, although half and half may also be an option.

One issue with the devices in the above mentioned Chinese patents is that negative stiffness is unstable, so the diaphragm attached to the movable magnet(s) will not want to maintain one angular orientation, i.e. the slightest unevenness in magnetic pull on different parts of the diaphragm will have a runaway effect causing the diaphragm to tilt unpredictably, in the least this will result in unpredictable harmonics, it may also result in magnet collisions. A solution to said issue is not to allow the different magnetic parts, on the diaphragm to move independently from each other, for example the magnetic parts on the diaphragm may all be attached to a single rigid object that moves by tilting on a hinge, like a door, this will eliminate the instability and unpredictability, but the diaphragm will still tilt, so a simple mechanism that is commonly utilizes in reading lamps, that allows the lamp to be repositioned without causing it to simultaneously tilt, can be utilized here as well, other techniques using tension members that extend from the diaphragm and converge to a single point before connecting to a negative stiffness element(s) (magnet(s)) can be found in several of the accompanying drawings.

The English translation of said Chinese patents is not clear, but to create a PNSD that doesn't just reflect sound energy, but absorbs it, damping is necessary, and various things that absorb sound, will absorb more sound when placed inside of a PNSD's air chamber, this is because the sound level inside of a PNSD's air chamber is a lot more concentrated than it is outside, however the impedance is much lower. A PNSD has low impedance, i.e. the diaphragm, and the air near the diaphragm, have a lot of velocity but not a lot of force compared to, say, a bass traps, so the following are some thoughts on how to take advantage of that: any type of absorber, e.g. a porous absorber, either on the inside or on the outside of the diaphragm can work better if it has relatively low impedance, one example of an outside absorber is a tube-bass-trap, inside of which the PNSD is placed, but to lower the impedance the holes in the rigid tube need to be bigger or more plentiful, and it may help if the absorbing material is thinner or more porous, although perhaps a better option is to use a small damper 63 that connects to the diaphragm because it's small and light and its impedance may be adjustable by simply adjusting the leverage. Internal absorbers may include a thin porous absorbing layer near to and parallel to the diaphragm, in which case the internal air pressure changes will be almost completely of an adiabatic nature. Another possibility is to fill the entire chamber with porous absorbing material, however this may present a problem because if said material is not porous enough, the impedance may be too high, but if it is too porous the isothermal process may not be smooth, i.e. the heat transfer may not be quick enough, this will result in a device that may be either to stiff or unstable, but it should not be counted out. Other variations that the Chinese patents seem not to refer to, and that this application may like to claim, is a PNSD that absorbs sound and/or reflects sound away from itself, that uses a negative stiffness element that utilizes leverage ratios that change based on position, and/or that utilizes repelling magnets.

Regarding a Non-Stretch Layer Held Taut by Air Pressure:

A non-stretch layer held taut by air pressure, as it pertains to a conventional speaker, was given special attention in previous sections of this document because a conventional speaker needs to be designed a certain way so that it can produce decent sound at a decent amplitude (diaphragm displacement), but there are many applications that are not so demanding, e.g. sound absorbers and sound reflectors (blockers) and resonators, utilizing a non-stretch layer, whether they utilize negative stiffness or not, would require a much smaller diaphragm displacement, and in a noisy environment like an aircraft their effect on sound quality is also not important, even speakers that are designed specifically for noise canceling in a noisy environment like an aircraft don't need to be able to produce decent sound, and they also only require small diaphragm displacement (because they can anyway only cancel the bit of noise that happens to pass right next to them), all of said products can benefit from a non-stretch layer held taut by air pressure whether said non-stretch layer makes up part of the enclosure wall or part of the diaphragm(s).

A stiff light-weight structure can connect the wall of said enclosure to at least one or two of the following: a damper, a mass, a spring, a lever, a negative stiffness element (e.g. a pair of attracting magnets), a speaker motor (e.g. a magnet and a voice coil or a balanced armature), and create a sound absorber or a resonator or a PNSD or an active noise canceling device. Note that each of these, including various combinations of these, may be in separate claims.

A stiff structure can comprise relatively light weight materials that have a high young's modulus, e.g. aramid, said structure need not be all that stiff to function, but stiffer is better. Using light-weight materials is good because it allows it to be made thicker and therefore stiffer. A stiff structure may utilize tension, instead of compression, when possible, but more importantly, it may avoid forces that try to force bending in a member/structure, when possible, it may borrow techniques from crane designs, and such. It can be beneficial if said stiff structure can carry the vibrational signal without significantly warping it, e.g. trying to attain a sound signal from a guitar string by measuring its longitudinal forces rather than its transverse ones, will result in a warped signal, because said forces (as well as motions) are nonlinearly related, a diaphragm can be thought of as a guitar string, It can also be beneficial if the damper is significantly linear (having a significantly linear force-vs-velocity function curve starting from x=0 and y=0).

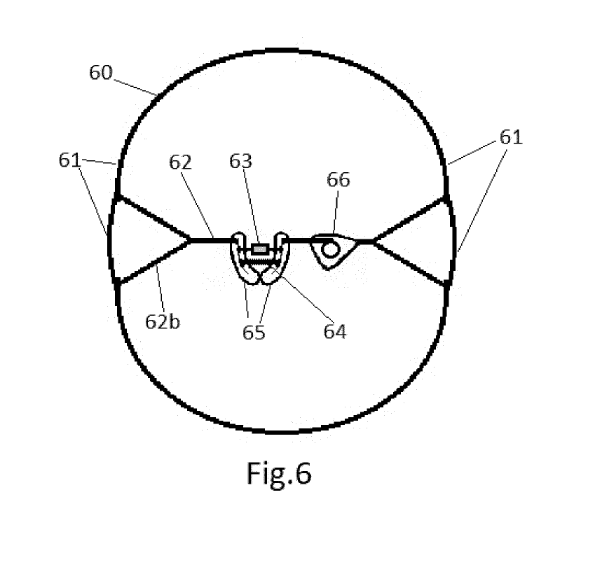

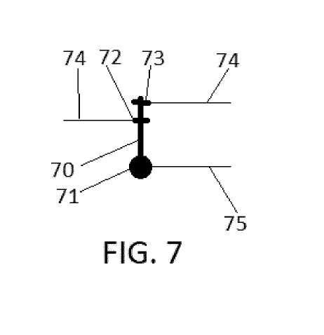

FIG. 6 shows a cross section of one example of an embodiment of an enclosure 60 (somehow these enclosure walls 60 look a lot thicker than I would have liked, but I don't have time to fix it), including diaphragms 61, that comprises a non-stretch layer 60 and 61 held taut by air pressure, it's shape is an oval, and a tension member assembly 62 connects the front of said oval to the back of said oval (the terms ‘front’ and ‘back’ here are arbitrary), where said tension member assembly 62 is, perhaps, twenty percent shorter than said oval diameter, thus deforming said oval, a plurality of non-stretch tension members arranged in cone-shape formations 62b connect the tension member assembly 62 to the oval, much of the tension member assembly 62 is comprised of non-stretch material, but the tension member assembly 62, also comprises a small damper 63 and a spring 64, between two very stiff, curved, rods/levers 65, where the bottom ends of said rods/levers 65 are in firm, and nonslip, contact with each other. The spring 64 allow the front, and also the back, of said oval (enclosure) to act as compliant diaphragms 61 that can vibrate when exposed to lower frequency sound. Spring 64 is connected alongside said small damper 63 and serves to keep said damper 63 from being extended to its maximum while allowing said damper 63 to damp the vibrating front, and back, diaphragms 61. The damping impedance of the diaphragms 61, can be adjusted by repositioning some of the force (contact) points on said levers 65 (see earlier descriptions for other possible mechanisms for adjusting leverage), adjusting the damper's 63 position on said levers 65 will affect the damping impedance.

Besides spring 64 the tension member assembly may also comprise a secondary spring 66, where said secondary spring 66 is perhaps five or ten times more compliant than spring 64 (e.g. being very long, but coiled up, perhaps inside of a pully wheel 66 that it is designed to turn), so that it will pick up most of the slack when the enclosure 60 shrinks (by as much as, perhaps, thirty percent or more) due to barometer and altitude change and slow air leakage etc., where said secondary spring 66 cannot respond to fraction-of-a-second vibrations because it engages through a gear-enhanced-flywheel 66 (a mass that is significantly amplified by leverage) that slows it down.

One way to (manually or automatically) increase the effective mass of the front and back diaphragms 61, without actually physically adding mass, is by using a very stiff rod 70, perhaps four inches long, with only a light weight on one end 71, one can see that by applying two clamps to said rod, one four-inches from said weight, and the other three-inches from said weight, where one clamp 72 is stiffly connected to the vibrating front diaphragm 61, and the other clamp 73 is stiffly connected to the vibrating back diaphragm 61, the diaphragms 61 can be made to resonate as though significant amounts of mass were added to both i.e. the light mass 71 at the end of the rod 70 has been significantly amplified due to leverage, said rod 70 can be held in an orientation that is perpendicular to the forces of the tension member assembly 74, by way of a tension member 75 that connects to a compliant spring that can be anchored to almost anything. The result is possibly the lightest resonator in the world, ideal for aircraft.

Regarding Blocking the Lower Frequencies with Light-Weight Aircraft Walls:

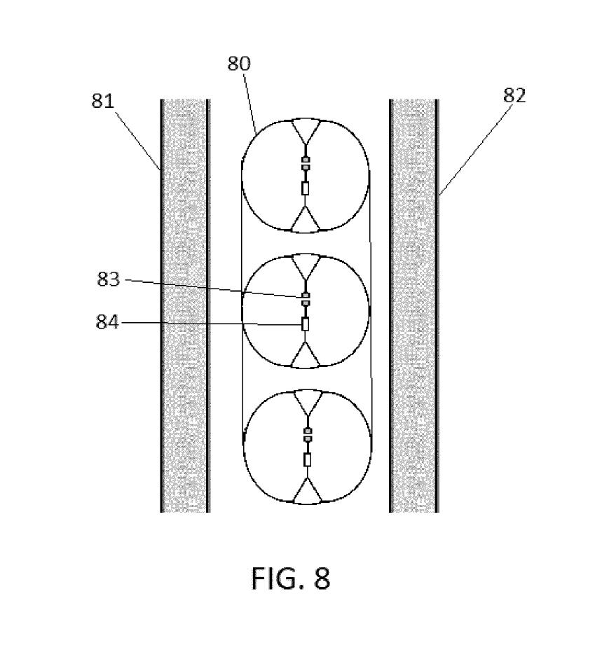

Because of its light weight, a non-stretch layer is particularly useful on aircraft, and as explained earlier PNSD, because of their low impedance, are particularly good at blocking low frequency noise when combined with high impedance barriers like walls, and they work even better if they are placed inside of a wall, between the inner and outer panels, where all connections between said inner and outer panels are not stiff but a little springy. FIG. 8 shows a cross section of what can be an aircraft wall filled with PNSD 80, a curtain of PNSD 80 is positioned between an inner panel 81 and an outer panel 82, this removes the air stiffness between the panels, so that if one panel vibrates, the other panel is not compelled to vibrate, thus the noise is blocked (reflected). These PNSD 80 are similar to the enclosure described in FIG. 6 except that the springs and levers and damper were removed from the tension member assembly 62 and replaced with a negative stiffness element 83, e.g. two attracting magnets, this allows the diaphragms 61 to vibrate very easily, and next to the negative stiffness element 83 is a mechanism 84 that was earlier described as a ‘secondary mechanism’ that regularly make small adjustments to the size of the enclosure, it does so by making the tension member assembly 62 slightly shorter and longer, and in doing so it pulls and pushes small amounts of air through a tiny hole that connects to a tube that connects to a slightly pressurized air source that supplies many PNSD 80. In FIG. 8 the PNSD 80 may be offset from each other in the third dimension, also diaphragms are perpendicular to the wall panels, but other options may also work (there may be room for experimentation), for example, some or all of the diaphragms may be parallel to the wall panels, the diaphragms may even be touching or even be connected to the wall panels.

The negative stiffness element 83 and secondary mechanism 84 can be replaced with a speaker motor, e.g. a magnet and a voice coil or a balanced armature, preferably a balanced armature, and this light-weight speaker can mimic the PNSD, it can do so either by taking feedback from a microphone, or it can more closely mimic the PNSD by taking its feedback from the position of the diaphragm 61. Since such a noise canceling speaker is small with a small diaphragm displacement yet need to produce large soundwaves it's a good candidate for a balanced armature and even for magnet based negative stiffness because a voice coil will need a rather heavy magnet to accompany it and it will weigh down the plane.

What is claimed is:

1. An apparatus comprising negative stiffness combined with positive stiffness where said positive stiffness is created by leverage ratios that vary with position.

2. A speaker affixed to a pressurized enclosure.

3. negative stiffness applied to the air inside of an aircraft wall.
